(19) United States
(12) Patent Application Publication
(10) Pub. No.: US 2010/0287424 A1
(43) Pub. Date: Nov. 11, 2010

(54) Method of writing an operating systems (OS) image to a semiconductor device and the semiconductor device

(75) Inventor: Jin Hyoung Kwon, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/662,749

(22) Filed: May 3, 2010

(30) Foreign Application Priority Data
May 8, 2009 (KR) 10-2009-0040272

(51) Int. Cl. G06F 12/00; G06F 9/24; G06F 11/26; G06F 12/08

(52) U.S. Cl. 714/718; 711/154; 713/2; 711/147; 711/E12.001; 711/E12.016; 714/E11.159

(57) ABSTRACT

Example embodiments are directed to a method of writing an Operating System (OS) image to a semiconductor device having a data storage device, an Application Specific Integrated Circuit (ASIC), and a non-volatile memory. The method includes initializing a DRAM interface of the ASIC using a boot loader, receiving the OS image input from a data writer to the semiconductor device through the DRAM interface; and writing the OS image into the non-volatile memory of the semiconductor device using a Flash Translation Layer (FTL) code.

### CROSS-REFERENCE TO RELATED APPLICATIONS

This application claims priority under 35 U.S.C. §119 to Korean Patent Application No. 10-2009-0040272, filed on 8 May 2009, in the Korean Intellectual Property Office, the disclosure of which is incorporated herein by reference in its entirety.

### BACKGROUND

1. Field

Example embodiments relate to a method of writing an OS (operating system) image to a semiconductor device, and particularly, to writing an OS image from a data writer to a semiconductor device using a DRAM interface and the semiconductor device used therein.

2. Description

A semiconductor device including a non-volatile memory, an Application Specific Integrated Circuit (ASIC) and/or a memory device may be used in a data processing system, such as a smart card, a memory card, a data storage apparatus, a SSD (Solid State Disc) used for image pickup device, camera, mobile telephone, PDA, PMP, Digital TV, Set top box, navigation device, game machine or computer. The semiconductor device may have an OS (Operating System) image in the non-volatile memory.

A data writer (a ROM writer, for example) may be used to write the OS image to the non-volatile memory of the semiconductor device.

### SUMMARY

According to example embodiments, a method of writing an operating system (OS) image to a semiconductor device including a data storage device, an Application Specific Integrated Circuit (ASIC) and a non-volatile memory, the method includes initializing at least one DRAM interface of the ASIC using a boot loader; receiving the OS image input from a data writer to the semiconductor device through the at least one DRAM interface; and writing the OS image into the non-volatile memory of the semiconductor device.

According to example embodiments, the method further includes initializing a first DRAM interface of the ASIC using the boot loader; storing the OS image in the data storage device, the OS image received from the data writer through a first interface of the data storage device; reading the stored OS image through a second DRAM interface of the data storage device, the second DRAM interface of the data storage device being connected to the first DRAM interface of the ASIC; and writing the OS image read from the data storage device to the non-volatile memory of the semiconductor device by the ASIC.

According to example embodiments, initializing the at least one DRAM interface of the ASIC includes receiving the boot loader from the data writer through a debug port and executing the received boot loader.

According to example embodiments, the method further includes receiving a Flash Translation Layer (FTL) code from the data writer through the debug port, and writing the OS image to the non-volatile memory of the semiconductor device in response to the received FTL code.

According to example embodiments, initializing the first DRAM interface of the ASIC includes receiving the boot loader from the data writer through a debug port and executing the received boot loader.

According to example embodiments, the method further includes receiving a Flash Translation Layer (FTL) code from the data writer through the debug port; storing the received FTL code in the data storage device; and using the FTL code to write the OS image to the non-volatile memory of the semiconductor device.

According to example embodiments, storing the OS image in the data storage device includes writing a first message in a first internal register of the data storage device requesting the OS image from the data writer; storing the received OS image in a shared memory bank of the data storage device in response to the first message; writing a second message in a second internal register of the data storage device indicating storage of the OS image; reading the second internal register and requesting access of the shared memory bank by writing a third message in the first internal register; and granting access of the shared memory bank using the first DRAM interface of the ASIC .

According to example embodiments, the method further includes receiving a Flash Translation Layer (FTL) code from the data writer through a debug port; storing the received FTL code in a first memory bank of the data storage device; and using the FTL code to write the OS image to the non-volatile memory of the semiconductor device.

According to example embodiments, a semiconductor device includes at least one non-volatile memory; at least one data storage device configured to receive and store an Operating System (OS) image input from a data writer according to a DRAM protocol; and at least one Application Specific Integrated Circuit (ASIC) configured to receive the OS image from the at least one data storage device and write the received OS image to the at least one non-volatile memory.

According to example embodiments, the at least one ASIC includes at least one DRAM interface configured to receive the OS image from the at least one data storage device according to the DRAM protocol; and at least one debug port configured to receive a boot loader from the data writer, wherein the DRAM interface is initialized in response to executing the received boot loader.

According to example embodiments, the at least one ASIC includes a processor connected to the at least one DRAM interface and the at least one debug port and the processor executing the boot loader to initialize the at least one DRAM interface.

According to example embodiments, the at least one ASIC further includes a non-volatile memory interface connected to the processor and configured to receive the OS image from the processor using a non-volatile memory protocol.

According to example embodiments, the at least one debug port is configured to receive a Flash Translation Layer (FTL) code from the data writer and the at least one ASIC stores the received FTL code in the at least one data storage device and writes the OS image stored in the at least one data storage device to the at least one non-volatile memory device.

According to example embodiments, the at least one data storage device includes a first port connected to the at least one DRAM interface of the at least one ASIC according to the DRAM protocol; a second port connected to the data writer according to the DRAM protocol; and a shared memory bank configured to be selectively accessed by the at least one ASIC through the first port and by the data writer through the second port based on an access authority, wherein the OS image received from the data writer is transferred to the at least one ASIC through the second port, the shared memory bank and the first port in that order.

According to example embodiments, the at least one data storage device further includes a first memory bank dedicated to the first port and accessed by the at least one ASIC; and a second memory bank dedicated to the second port and accessed by the at least one data writer.

According to example embodiments, the OS image is stored in the shared memory bank through the second port.

According to example embodiments, a Flash Translation Layer (FTL) code received from at least one debug port is stored in the first memory bank through the first port.

According to example embodiments, the at least one data storage device includes a first port connected to the at least one ASIC using a DRAM protocol; a second port connected to at least one Field Programmable Gate Array (FPGA) according to the DRAM protocol, and configured to receive the OS image input from the data writer; a memory area including a plurality of memory cells, the plurality of memory cells configured to store data provided by the first and second ports; and an access controller configured to control access of the memory area by the at least one FPGA and the at least one ASIC.

According to example embodiments, the at least one data storage device includes a first port connected to the at least one ASIC using a DRAM protocol; a second port connected to at least one Field Programmable Gate Array (FPGA) according to the DRAM protocol, and configured to receive the OS image input from the data writer; a plurality of memory banks and plurality of internal registers.

According to example embodiments, the plurality of banks include at least one first memory bank dedicated to the first port and accessed by the at least one ASIC, at least one second memory bank dedicated to the second port and accessed by the at least one FPGA, and at least one shared memory bank accessed by the at least one ASIC and the at least one FPGA using the first and second ports, respectively.

According to example embodiments, the plurality of internal registers include a semaphore register configured to indicate an access authority of the first and second ports over the at least one shared memory bank, a plurality of mail box registers configured to transmit messages between the first and second ports, a plurality of check registers configured to indicate whether a message transmitted to the first or second port is read by the corresponding first or second port, and at least one reserved register.

According to example embodiments, the plurality of internal registers are configured to ensure that the at least one FPGA and the at least one ASIC do not access the shared memory bank simultaneously.

According to example embodiments, the at least one ASIC includes a plurality of controllers, a first controller of the plurality of controllers connected to the at least one data storage device using the DRAM protocol and configured to receive the OS image from the at least one data storage device, and a second controller of the plurality of controllers connected to the at least one non-volatile memory and configured to write the received OS image to the at least one non-volatile memory; an internal non-volatile memory configured to store a first boot loader, the first boot loader configured to initialize the first controller, and a Flash Translation Layer (FTL) code, the FTL code configured to change a logical address to a physical address; and a processor configured to execute the first boot loader stored in the internal non-volatile memory and initialize the first controller, and store the FTL code in the at least one data storage device using the first controller.

According to example embodiments, the at least one ASIC includes a plurality of controllers, a first controller of the plurality of controllers connected to the at least one data storage device using the DRAM protocol and configured to receive the OS image from the at least one data storage device, a second controller of the plurality of controllers connected to the at least one non-volatile memory and configured to write the received OS image to the at least one non-volatile memory, and a third controller of the plurality of controllers connected to the data writer using a Joint Test Action Group (JTAG) protocol and configured to receive a first boot loader and a Flash Translation Layer (FTL) code from the data writer; a processor configured to execute a second boot loader stored in an internal non-volatile memory of the at least one ASIC, and configured to store the first boot loader received from the third controller in an internal volatile memory of the at least one ASIC and configured to execute the stored first boot loader; and a bridge configured to change a protocol of data transferred between a plurality of buses of the at least one ASIC.

According to example embodiments, a data processing system (DPS) includes a data writer including a processor, at least one field programmable gate array (FPGA) and at least one memory connected to the at least one FPGA; and at least one semiconductor device including at least one data storage device, at least one Application Specific Integrated Circuit (ASIC) and at least one non-volatile memory, wherein the data writer is connected to the at least one semiconductor device using a DRAM protocol, and the data writer is configured to transfer an Operation System (OS) image to the at least one semiconductor device using the DRAM protocol.

According to example embodiments, the data writer is connected to the at least one semiconductor device using a Joint Test Action Group (JTAG) protocol, and the data writer is configured to transfer a first boot loader and Flash Translation Layer (FTL) code to the at least one semiconductor device using the JTAG protocol.

According to example embodiments, an Application Specific Integrated Circuit (ASIC) includes a plurality of controllers, a first controller of the plurality of controllers connected to at least one data storage device using a DRAM protocol and a second controller of the plurality of controllers connected to at least one non-volatile memory; an internal non-volatile memory storing a first boot loader, the first boot loader used to initialize the first controller, and a Flash Translation Layer (FTL) code, the FTL code used to change a logical address to a physical address; and a processor configured to execute the first boot loader stored in the internal non-volatile memory and initialize the first controller, and configured to store the FTL code in the at least one data storage device using the first controller.

According to example embodiments, an Application Specific Integrated Circuit (ASIC) includes a plurality of controllers, a first controller of the plurality of controllers connected to at least one data storage device using a DRAM protocol, a second controller of the plurality of controllers connected to at least one non-volatile memory and a third controller of the plurality of controllers connected to a data writer using a Joint Test Action Group (JTAG) protocol; a processor configured to execute a first boot loader stored in an internal non-volatile memory of the ASIC, and configured to execute a second boot loader stored in an internal volatile memory of the ASIC; and a bridge configured to change a protocol of data transferred between a plurality of buses of the ASIC.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates a data writer according to example embodiments;

FIG. 2 illustrates a block diagram of a data processing system including a data writer and a plurality of semiconductor devices, according to example embodiments;

FIG. 3 illustrates a block diagram a data storage device as shown in FIG. 2, according to example embodiments;

FIG. 4 illustrates a block diagram a data storage device as shown in FIG. 2, according to example embodiments;

FIG. 5 illustrates a block diagram a Application Specific Integrated Circuit (ASIC) as shown in FIG. 2, according to example embodiments;

FIG. 6 is a flow chart illustrating a method of writing in the data processing system of FIG. 2, according to example embodiments;

FIG. 7 illustrates a block diagram of a data processing system including a data writer and a plurality of semiconductor devices, according to example embodiments;

FIG. 8 illustrates an ASIC of FIG. 7, according to example embodiments; and

FIG. 9 is a flow chart illustrating a method of writing in the data processing system of FIG. 7, according to example embodiments.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

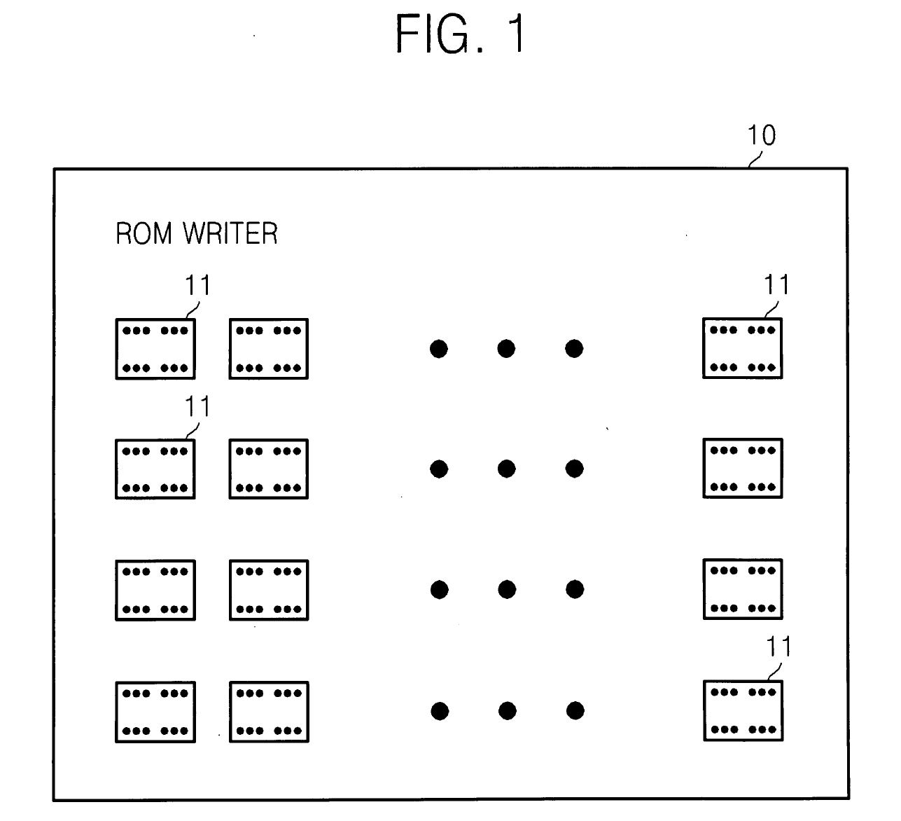

FIG. 1 shows a configuration of a data writer according to example embodiments.

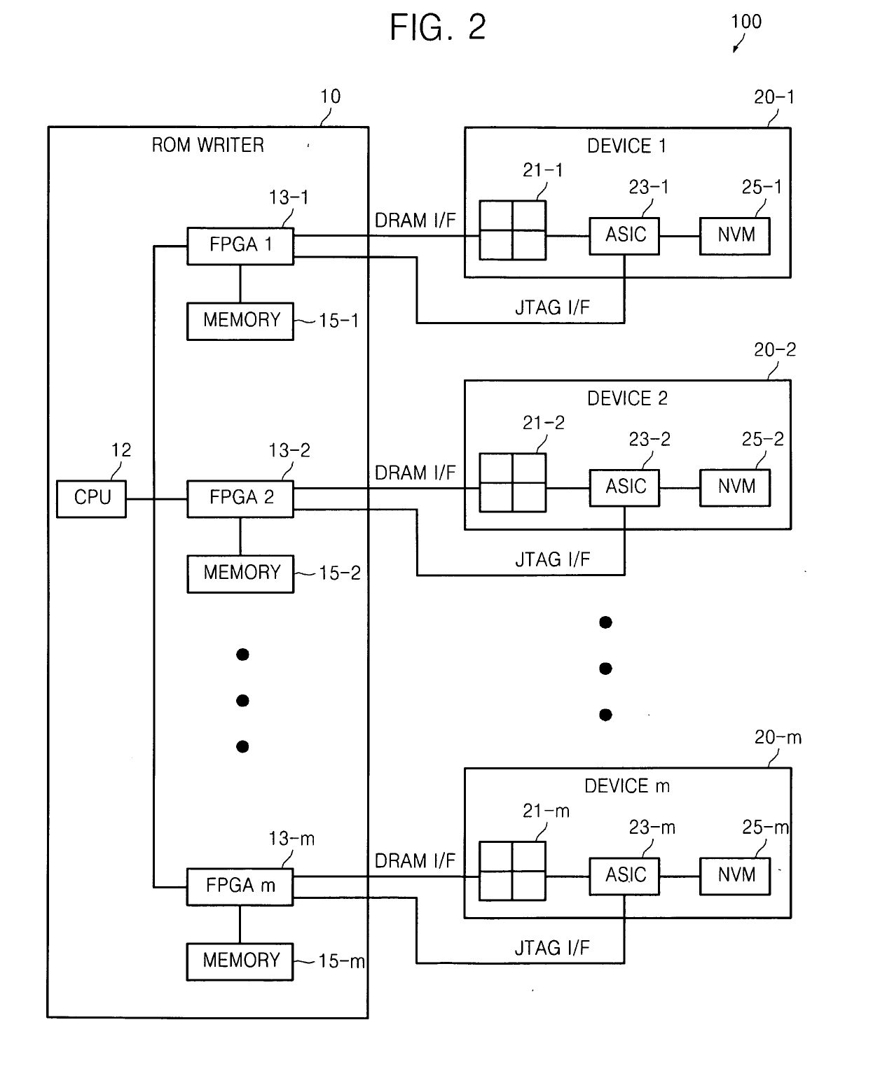

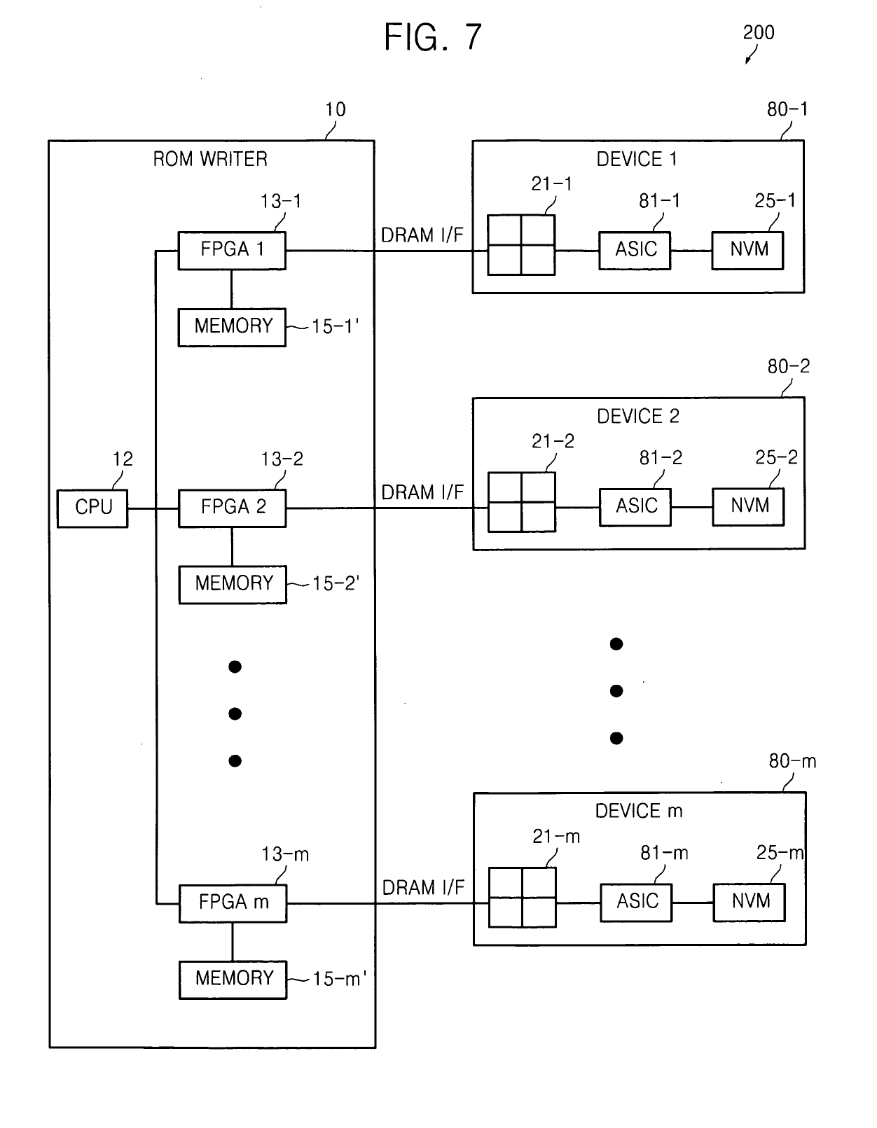

Referring to FIG. 1, the data writer 10 includes a plurality of sockets 11. Each of the plurality of sockets 11 may hold a semiconductor device as shown in FIGS. 2 and/or 7. The data writer 10 may be similar to an equipment that may write data or program, such as OS image or image file, to the semiconductor devices as shown FIG. 2 and/or FIG. 7 and may be referred to as a ROM writer.

FIG. 2 shows a block diagram of an example data processing system including a data writer and a plurality of semiconductor devices.

Referring to FIG. 1 and FIG. 2, the data processing system 100 includes the data writer 10 and a plurality of semiconductor devices 20-1˜20-m. The data writer 10 may include CPU 12, a plurality of programmable logic chips, such as a plurality of FPGAs (Field Programmable Gate Arrays) 13-1˜13-m and/or a plurality of memories 15-1˜15-m. The CPU 12 may control both overall operation of the data writer 10 and operations of the plurality of FPGAs 13-1˜-m. Each of the plurality of FPGAs 13-1˜13-m may control the writing of an OS image stored in a corresponding memory 15-1˜15-m to a non-volatile memory (NVM) 25-1˜25-m of the corresponding semiconductor device 20-1˜20-m. This operation may be conducted in response to signal(s) output from each of the semiconductor devices 20-1˜20-m under the control of the CPU 12 or independent of the CPU 12.

For instance, each of the plurality of memories 15-1˜15-m may include a plurality of volatile memory cells, such as DRAM cells or SRAM cells. Data stored in each of the plurality of memories 15-1˜15-m may include, for example, a second boot loader, FTL (Flash Translation Layer) and OS (Operating System) image or a file including an OS image.

Each of the plurality of semiconductor devices 20-1˜20-m may include data storage devices 21-1˜21-m, ASIC's (Application Specific Integrated Circuits) 23-1˜23-m and NVM's 25-1˜25-m. The semiconductor devices 20-1˜20-m may either be as a single chip including data storage devices 21-1˜21-m, ASIC's 23-1˜23-m and NVM's 25-1˜25-m or a package with individual data storage devices 21-1˜21-m, ASIC's 23-1˜23-m and NVM's 25-1˜25-m.

The data storage device 21-1 interfaces with a corresponding FPGA 13-1 of the data writer 10 using a DRAM interface/protocol DRAM I/F. The data storage device 21-1 may have a memory link architecture MLA and may be a multi port memory device having more than two ports.

The ASIC 23-1 interfaces with a corresponding FPGA 13-1 of the data writer 10 using a JTAG (Joint Test Action Group) interface/protocol JTAG I/F. In addition, the ASIC interfaces with both the data storage device 21-1 and the NVM 25-1. The ASIC's 23-1˜23-m may function as a processor to write OS image to the each of the NVM's 25-1˜25-m.

The NVM 25-1 may store an OS image transmitted from the data writer 10 in accordance with the DRAM protocol. The NVM 25-1 may be one of an EEPROM (Electrically Erasable Programmable Read-Only Memory), flash memory, MRAM (Magnetic RAM), Spin-Transfer Torque MRAM, Conductive bridging RAM (CBRAM), FeRAM (Ferroelectric RAM), PRAM (Phase change RAM) also called as OUM (Ovonic Unified Memory), Resistive RAM (RRAM or ReRAM), Nanotube RRAM, Polymer RAM: (PoRAM), Nano Floating Gate Memory (NFGM), Holographic memory, Molecular Electronics Memory Device, and Insulator Resistance Change Memory. Memory cell of each of the NVM may store one bit or multi-bit information. The NVM may also be a ROM.

Each of the FPGAs 13-1˜13-m may transfer the second boot loader and a FTL code to the corresponding semiconductor memory devices 20-1˜20-m using the JTAG interface (for example, a debug port). Thereafter, each FPGA 13-1 may send an OS image to the corresponding semiconductor device using the DRAM interface.

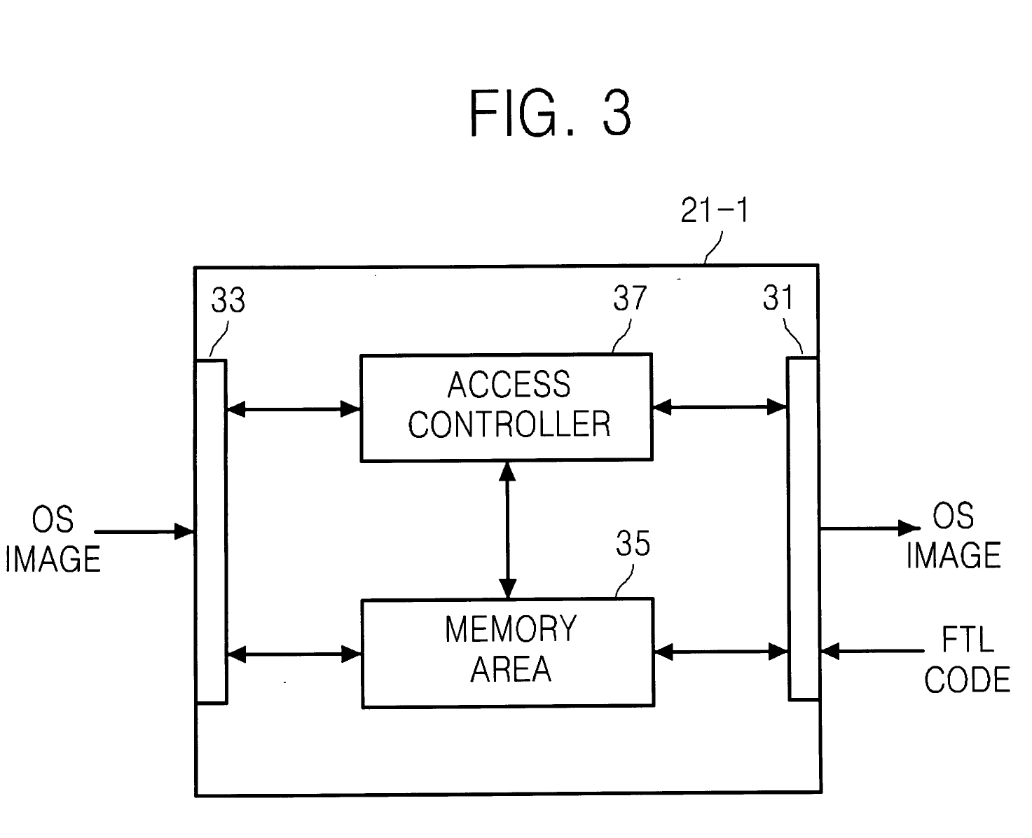

FIG. 3 shows a block diagram of a data storage device 21-1 of FIG. 2 according to example embodiments. Other data storage devices may be implemented similarly. However, implementations are not limited thereto.

Referring to FIG. 3, the data storage device includes first port 31, second port 33, memory area 35 and an access controller 37. Each of the first 31 and the second port 33 may be a DRAM interface (e.g. hardware or software) to process input/output signals in accordance with a DRAM protocol. According to example embodiments, each port 31,33 may be an interface that utilizes a SRAM protocol.

The memory area 35 may include a plurality of volatile memory cells or non-volatile cells that store FTL and/or OS image. The access controller 37 may control an operation for the ASIC 23-1 to access the memory area 35 using the first port 31 and an operation for the FPGA 13-1 to access the memory area 35 using the second port 33.

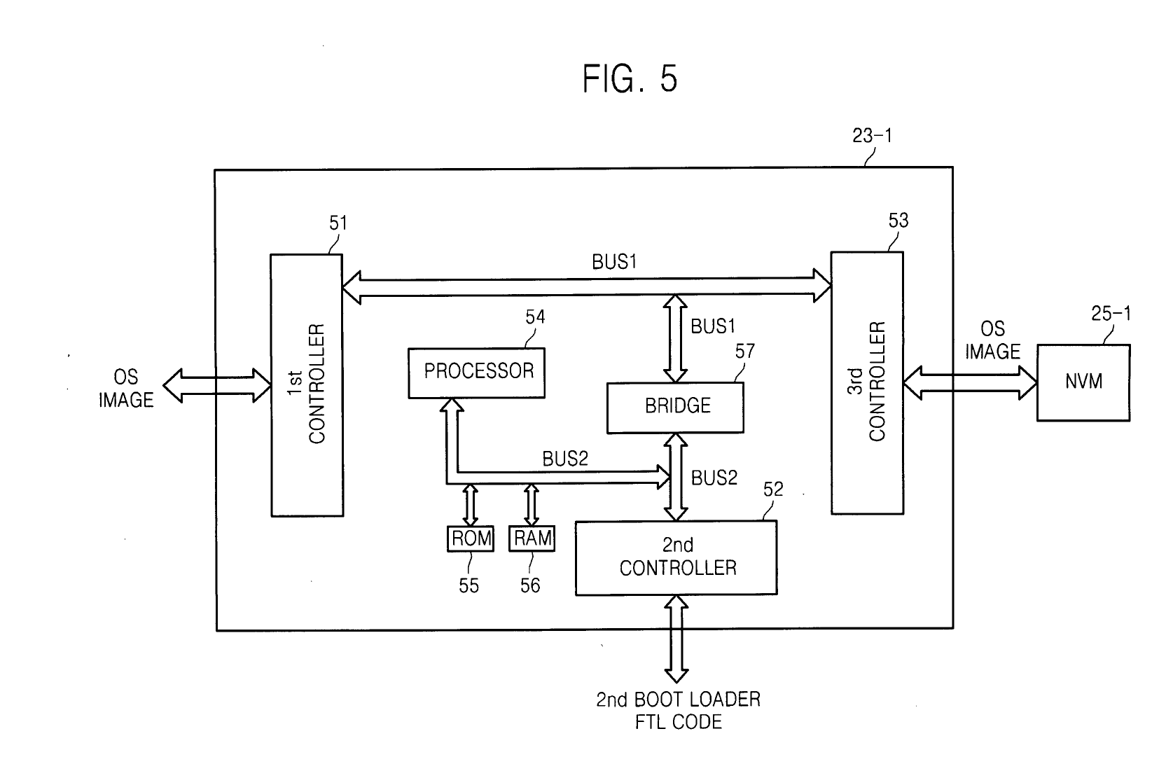

The first port 31 interfaces data, such as OS image or FTL code, with a first controller 51 of the ASIC as shown in FIG. 5 according to the DRAM protocol and/or the SRAM protocol. The second port 33 interfaces data, such as OS image, with FPGA 13-1 according to the DRAM protocol and/or the SRAM protocol.

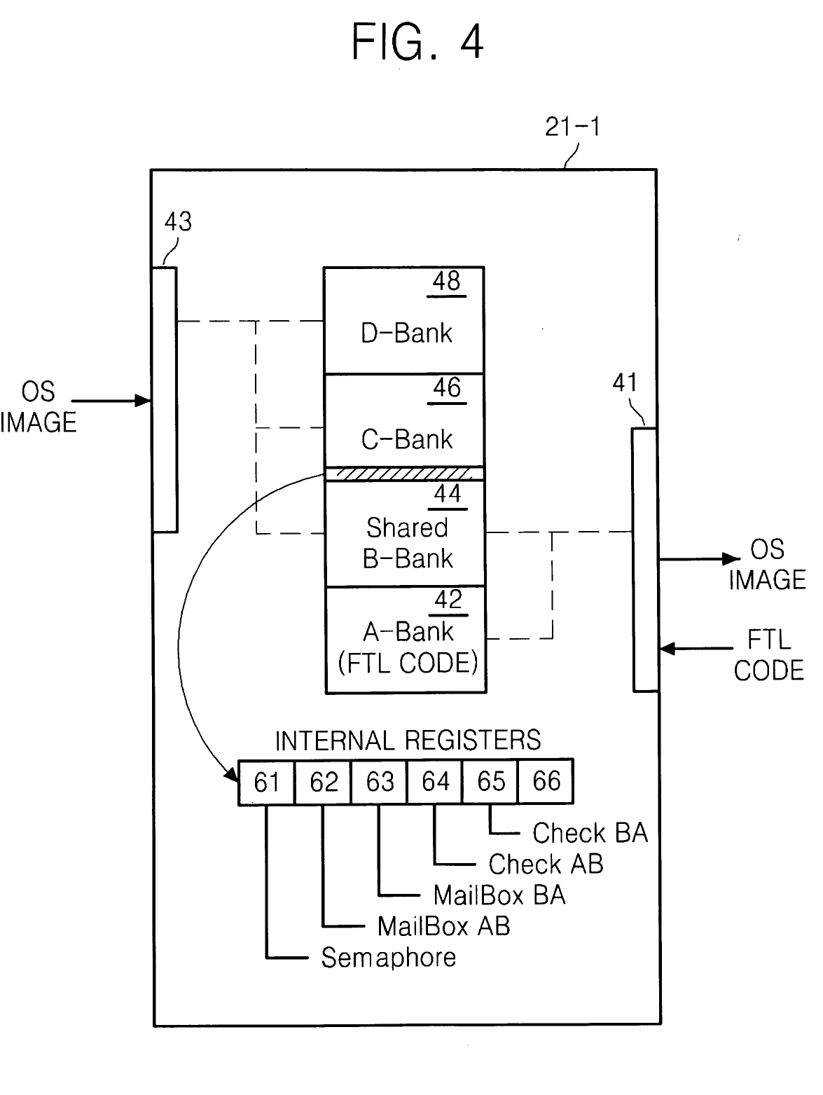

FIG. 4 shows a block diagram of a data storage device 21-1 of FIG. 2 according to example embodiments.

Referring to FIG. 4, the data storage device 21-1 may include first port 41 (port A), a plurality of memory banks 42, 44, 46 and 48, and a second port 43 (port B). The first port 41 interfaces with ASIC 23-1 through the first controller 51 of the ASIC 23-1 and the second port 43 interfaces with the FPGA 13-1. The first port 41 and the second port 42 may be an interface that can interface data according to one of DRAM protocol and SRAM protocol.

The memory bank 42 may be dedicated to the ASIC 23-1 through the first port 41, and the memory bank 46, 48 may be dedicated to the FPGA 13-1 or the CPU 12 through the second port 43. The memory bank 44, also referred to as shared B-Bank, may be a shared memory bank that can be accessed by the ASIC 23-1 or FPGA 13-1 through the first port 41 or the second port 43, respectively.

The data storage device 21-1 includes internal registers 61-66 that have the same size as one row size of the shared memory bank 44, for example 2 KB. However, example embodiments are not limited thereto, and the size of the internal registers 61-˜66 may be greater than or less than a size of the shared memory bank 44. When a row address indicating a specific region of the shared memory bank 44 is input, the specific region in the shared B-Bank may be disabled and the internal registers may be enabled. The internal registers 61-66 may include a semaphore register 61, mail box registers 62, 63, check registers 64, 65 and reserved register RVD 66. The internal registers 61-66 may solve a confliction situation when the FPGA 13-1 and the ASIC 23-1 simultaneously access the shared memory bank 44 and may support permission of access authority and data transmission between the first port 41 and the second port 43.

The semaphore register 61 may store a bit indicating which port, e.g., the first port 41 or the second port 43, has the access authority over the shared memory bank 44. For instance, a value “0” of the semaphore register 61 may indicate that the first port 41 has the access authority over the shared memory bank 44 and a value of “1” of the semaphore register 61 may indicate that the second port 43 has the access authority over the shared memory bank 44, and vice versa. The value of the semaphore register 61 can be written only by a port having the access authority over the shared memory bank 44. The semaphore register 61 may be a 1-bit register or a 2-bit register, however, the size of the semaphore register is not limited thereto.

The mail box registers 62 and 63 may be used to transmit messages (e.g., the position and size of write or read data and a command) or short data. For instance, to transmit a message from the first port 41 to the second port 43, a mail box register AB 62 may be used by the first port 41 to write and used by the second port 43 only to read. Contrarily, to transmit a message from the second port 43 to the first port 41, a mail box BA 63 can be used by the second port 43 to write and used by the first port 41 only to read. An interrupt signal is generated if message is written into each mail box register by a corresponding port. For instance, the interrupt signal is generated and sent to the second port 43 if the mail box register AB 62 is written by the first port 41.

A value of a check signal of each of the check registers 64 and 65 may indicate whether a message written to the mail box register 62 or 63 is read by an opposite port. The value of each check register 64 or 65 may be automatically changed according to a read/write command output from the mail box registers 62 or 63. For instance, when the first port 41 writes a message to the mail box register AB 62, the value of the check register 64, i.e., check AB may be set to “1”. When the second port 43 reads the mail box AB, the value of the check register 64, check BA may be set to “0”. However, example embodiments are not limited thereto and alternatives are also possible.

An operation wherein the access authority over the shared memory bank 44 is transferred from the second port 43 to the first port 41 is now described with reference to FIG. 4.

When the value of the semaphore register 61 is set to “1”, the FPGA 13-1 can access the shared memory bank 44 and the dedicated memory banks 46, 48 using the second port 43, while the ASIC 23-1 can access the dedicated memory bank 42 but not the shared memory bank 44.

In the first operation, the ASIC 23-1, reads the value (e.g., “1”) of the semaphore register 61 via the first port 41 to check the access authority. In the second operation, the ASIC 23-1 writes a message requesting to transfer the access authority to the mail box register AB 62 via the first port 41. Then, an interrupt signal is activated to inform the FPGA 13-1 that the message has been written to the mail box register AB 62. In the third operation, the FPGA 13-1 reads the message written to the mail box register AB 62 via the second port 43 in response to the activated interrupt signal. In the fourth operation, the FPGA 13-1 changes the value of the semaphore register 61 from “1” to “0” via the second port 43. The FPGA 13-1 writes a message indicating that the value of the semaphore register 61 has been changed from “1” to “0” to the mail box register BA 63. The ASIC 23-1 reads the message written to the mail box register BA 63 via the first port 41. In the fifth operation, the ASIC 23-1 reads the value of the semaphore register 61 via the first port 41 and confirms that the access authority over the shared memory bank 44 has been transferred.

The procedure of transfer of the access authority over the shared memory bank 44 from the first port 41 to the second port 43 is somewhat similar to the procedure described above of a detailed description thereof will be omitted for the sake of brevity.

FIG. 5 shows a block diagram of ASIC 23-1 as shown in FIG. 2 according to example embodiments. Other ASIC's may be implemented similarly. However, implementations are not limited thereto. Referring to FIG. 5, the ASIC 23-1 includes a plurality of controllers 51, 52, and 53, a processor 54, a ROM 55, a RAM 56, a bridge 57 and/or a plurality of buses BUS1 and BUS2.

The first controller 51 interfaces with the first port 31 (functioning as a DRAM interface) of the data storage device 21-1, and may be initialized or set to have an initial state on executing the second boot loader. The second controller 52 may interface with the FPGA 13-1 using the JTAG protocol and receive the second boot loader and the FTL from the data writer 10. The third controller 53 may interface with NVM 25-1 using a NAND protocol, for example.

The processor 54 may load and execute a first boot loader stored in the ROM 55 and also load and execute the second boot loader stored in the RAM 56 to initialize the first controller 51. Bridge 57 may change protocol of data transferred between the plurality of buses BUS1 and BUS2.

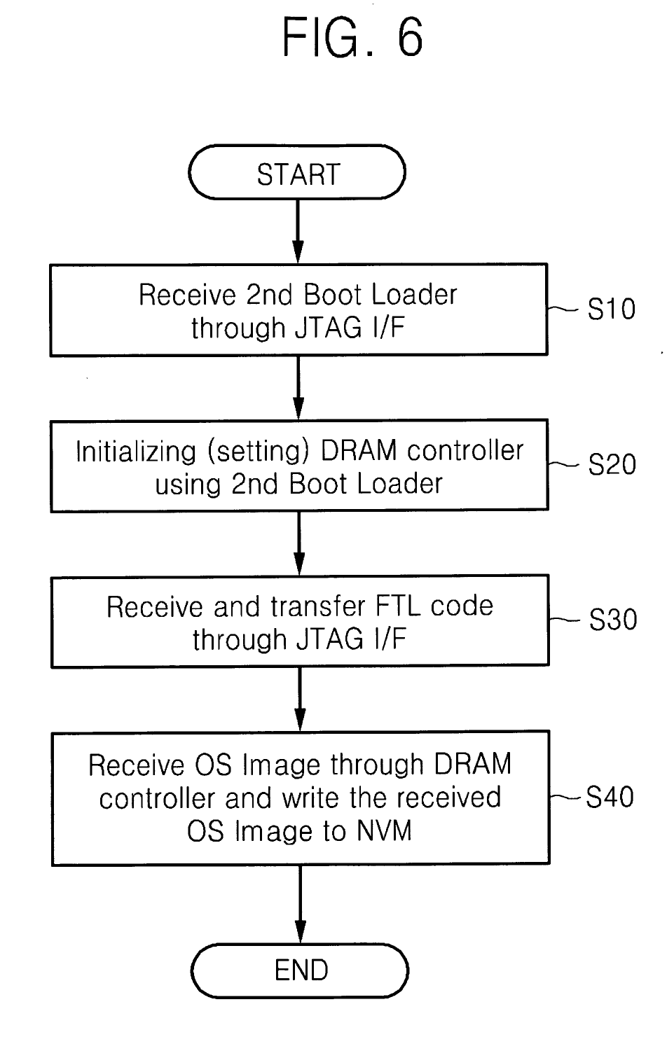

FIG. 6 shows a flow chart illustrating a writing method of the data processing system of FIG. 2. The method of writing an OS image in the data processing system will be described with reference to FIGS. 1-3, 5 and 6.

For the sake of brevity of explanation, the method of writing an OS image to the semiconductor device 20-1 inserted into one of the sockets 11 of the data writer 10 will be described.

The processor 54 of the ASIC 23-1 may load the first boot loader stored in the ROM 55 and then execute the first boot loader. FPGA 13-1 transfers the second boot loader stored in the memory device 15-1 to the second controller 52 of the ASIC 23-1 using the JTAG interface/protocol. The processor 54 stores the second boot loader input using the JTAG interface/protocol in the RAM 56 and then the processor 54 may initialize the first controller 51 by executing the second boot loader. FPGA 13-1 may then transfer FTL stored in the memory device 15-1 to the second controller 52 of the ASIC 23-1 using the JTAG interface/protocol. The first controller 51 may store the FTL input from the second controller 52 in the memory area 35 of data storage device 21-1 under the control of the processor 54. That is, the access controller 37 may store the FTL input from the first port 31 into the memory area 35 in response to a command and/or an address from the first controller 51.

As explained above, the first port 31 may be an interface suitable for supporting a protocol which can interface data with the first controller 51.

The access controller 37 may send a first signal to the FPGA 13-1 indicating that it is ready to receive the OS image after the FTL code is stored into the memory area 35. Also, according to example embodiments, the access controller 37 may send the first indicating signal to the processor 54 after the FTL code is stored into the memory area 35. In this case, the first indicating signal is transferred to the processor 54 through the first controller 51 and the bridge 57, and the processor 54 sends the first indicating signal to the FPGA 13-1 through the second controller 52.

FPGA 13-1 may send the OS image stored in the memory device 15-1 using the second port 33, such as DRAM interface/protocol or SRAM interface/protocol, in response to the first indicating signal. The access controller 37 may store the received OS image into the memory area 35 in response to a command and/or address received by the second port 33 from the FPGA 13-1. After storing the OS image into the memory area 35, the access controller 37 may send a second signal to the ASIC 23-1 through the first port 31 indicating that the OS image has been stored into the memory area 35. The processor 54 may read the OS image stored in the memory area 35 in response to the second indicating signal and write the OS image to the non-volatile memory 25-1 through the third controller 53.

A method of writing the OS image output from the FPGA 13-1 to the non-volatile memory 25-1 of the semiconductor device 20-1 using the DRAM interface/protocol will be described with reference to FIGS. 1-2 and 4-6.

After power is supplied to the data writer 10 and the semiconductor device 20-1 is inserted into the socket 11, the processor 54 reads and executes the first boot loader stored in the ROM 55.

The FPGA 13-1 reads the second boot loader stored in the memory 15-1 and transfers the second boot loader to the ASIC 23-1 using the JTAG interface/protocol of the second controller 52 (S10). The processor 54 stores the second boot loader into the RAM 56 and executes the stored second boot loader in order to initialize the first controller 51 (S20). Then the FPGA 13-1 reads the FTL code stored in the memory 15-1 and sends the FTL code to the ASIC 23-1 using the JTAG interface of the second controller 52. The processor 54 stores the FTL code received through the second controller 52 into the memory bank 42 (FIG. 4) via the first controller 51 and the first port 41 (S30).

In S40, the processor 54 writes a message indicating that it is ready to receive the OS image through the first port 41 in the mail box register Mailbox AB 62. At this time, a first interrupt signal is sent to the FPGA 13-1 through the second port 43. The FPGA 13-1 writes the OS image stored in the memory 15-1 into the shared memory bank 44 via the second port 43 in response to the first interrupt signal, and then the FPGA 13-1 writes a message indicating that the OS image is stored into the shared memory bank 44 in the mail box register Mailbox BA 63. At this time, a second interrupt signal is sent to the processor 54 via the first port 41.

The processor 54 reads the mail box register Mailbox BA 63 and writes a message requesting a change of access authority over the shared memory bank 44 in the mail box register Mailbox AB 62. At this time, the first interrupt signal is sent to the FPGA 13-1. The FPGA 13-1 changes the value of semaphore register 61 from 1 to 0 in response to the first interrupt signal and then the FPGA 13-1 writes a message indicating that the value of the semaphore register 61 has been changed from “1” to “0” in the mail box register Mailbox BA 63. At this time, the second interrupt signal is sent to the ASIC 23-1.

The processor 54 reads the value “0” of the semaphore register 61 through the first port 41 and verifies changing of the access authority over the shared memory bank 44. Accordingly, the processor 54 reads the OS image stored in the shared memory bank 44 via the first port 41 and the first controller 51 and writes the OS image to the non-volatile memory 25-1 through the third controller 53. At this time, the processor 54 may write the OS image to the non-volatile memory 25-1 using the FTL stored in the memory bank 42.

The processor 54 transfers the access authority of the shared memory bank 44 to the FPGA 13-1 after writing the OS image to the non-volatile memory 25-1. For instance, if an OS image is relatively large in size, the OS image can be divided into many parts and each part can be successively written to the non-volatile memory 25-1 through the DRAM interface using the same procedure as explained above.

Also, after S40, the FPGA 13-1 may read the OS image using the DRAM interface/protocol in order to verify the write operation of the OS image and may end the data writing operation if there is no error during the verification.

If the OS image is successfully written to the non-volatile memory of the semiconductor device 20-1 using the DRAM interface by the data writer 10, the semiconductor device 20-1 is detached from the socket 11 and then the semiconductor device 20-1 will be used with other devices and, in this case, the second port 43 of the data storage device 21-1 may be connected to a CPU. Also, the CPU and the semiconductor device 20-1 may be a data processing system, such as a smart card, a memory card, a data storage apparatus, a SSD (Solid State Disc) used for image pickup device, camera, mobile telephone, PDA, PMP, Digital TV, Set top box, navigation device, game machine or computer, or the like.

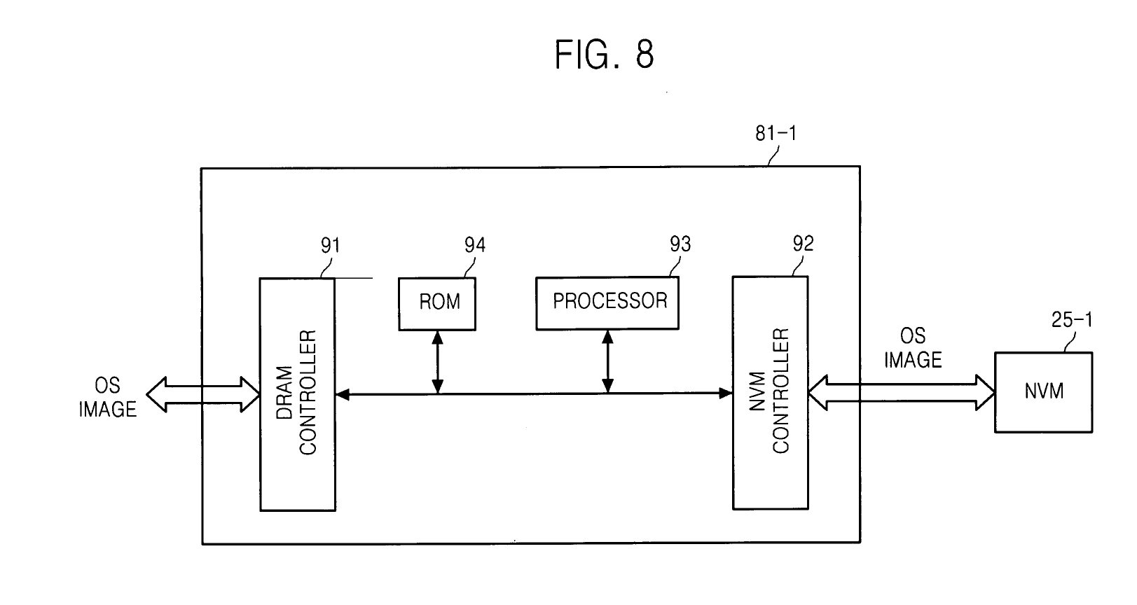

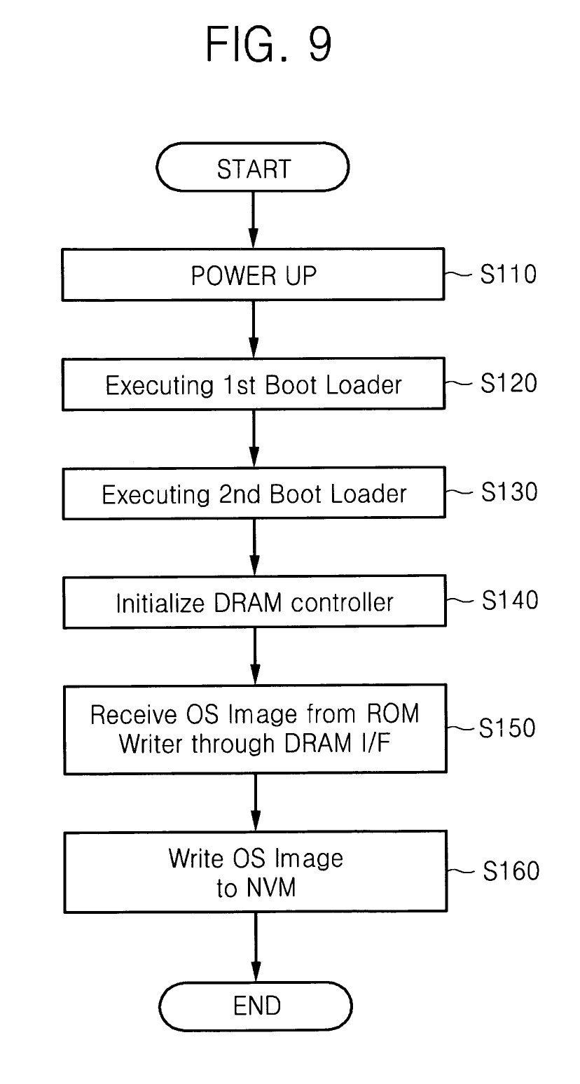

FIG. 7 shows block diagram of a data processing system including a data writer and a plurality of semiconductor devices, according to example embodiments. FIG. 8 illustrates an ASIC of FIG. 7 and FIG. 9 shows a flow chart illustrating a writing method of data processing system of FIG. 7.

Referring to FIG. 7, the data processing system 200 may have a configuration somewhat similar to that of the data processing system 100 of FIG. 2 except that there is no JTAG interface, used to transfer the second boot loader and the FTL code in the data processing system 100 of FIG. 2, between the data writer 10 and a plurality of semiconductor devices 80-1˜80-m. So, ASIC 81-1˜81-m in semiconductor devices 80-1˜80-m are different from the ASIC 23-1˜23-m of the semiconductor device 20-1˜20-m.

Referring to FIG. 8, the ASIC 81-1 may include a DRAM controller 91, NVM controller 92, a processor 93 and ROM 94. The DRAM controller 91 and the NVM controller 92 respectively may correspond to the first controller 51 and the third controller 53 of FIG. 5. The ROM 94 may store second boot loader that is used to initialize the DRAM controller 91 and may store the FTL code that is used to change a logical address into a physical address. The ROM 54 may be replaced by one of EEPROM (Electrically Erasable Programmable Read-Only Memory), flash memory, MRAM (Magnetic RAM), Spin-Transfer Torque MRAM, Conductive bridging RAM (CBRAM), FeRAM (Ferroelectric RAM), PRAM (Phase change RAM) also called an OUM (Ovonic Unified Memory), Resistive RAM (RRAM or ReRAM), Nanotube RRAM, Polymer RAM (PoRAM), Nano Floating Gate Memory (NFGM), Holographic memory, Molecular Electronics Memory Device Insulator Resistance Change Memory or the like.

A writing method of the OS image output from the FPGA 13-1 to the non-volatile memory 25-1 of the semiconductor device 80-1 will be described with reference to FIG. 1 and FIGS. 7 through 9.

When power is supplied to the data writer 10 and the semiconductor device 80-1 inserted into the socket 11 of the data writer 10 (S110), the processor 93 reads the first boot loader stored in the ROM 94 and executes the first boot loader (S120). Then, the processor 93 executes the second boot loader stored in the ROM 94 (S130) and initializes the DRAM controller 91 (S140). The processor 93 then stores the FTL stored in the ROM 94 into the memory area 35 of the data storage device of FIG. 3 or the memory bank 42 of the data storage device of FIG. 4 using the DRAM controller 91.

The processor 93 may then send a signal to the FPGA 13-1 indicating that it is ready to receive the OS image. The FPGA 13-1 reads the OS image stored in the memory 15-1 in response to the indicating signal and sends the OS image to the data storage device 21-1.

The access controller 37 stores the OS image received through the second port 33 into the memory area 35 and sends a signal to the DRAM controller 91 through the first port 31 indicating that the OS image is stored into the memory area 35. The processor 93 reads the OS image stored in the memory area 35 in response to the indicating signal and writes it into the non-volatile memory 25-1. Thus, the semiconductor device 80-1 may receive the OS image from the data writer 10 using the DRAM interface (S150) and may write the received OS image to the non-volatile memory 25-1(S160).

Alternatively, the FPGA 13-1 having the access authority of the shared memory bank 44 reads the OS image stored in the memory device 15-1 and writes the OS image into the shared memory bank 44 through the second port 43 using the DRAM interface and then transfers the access authority of the shared memory bank over to the ASIC 81-1. The ASIC 81-1 gets the access authority, receives the OS image written into the shared bank memory 44 through the first port 41 (S150) and writes the received OS image to the non-volatile memory 25-1(S160).

As explained above, the semiconductor device 80-1 connected to the data writer 10 through the DRAM interface receives and writes the OS image to the non-volatile memory 25-1 through the DRAM interface.

Although the semiconductor devices 20-1 or 80-1 are described to receive an OS image through the DRAM interface, the teachings may also be applied to a semiconductor device using SRAM interface to write the OS image to the non-volatile memory.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

1.-8. (canceled)

9. A semiconductor device comprising:
at least one non-volatile memory;
at least one data storage device configured to receive and store an Operating System (OS) image input from a data writer according to a DRAM protocol; and
at least one Application Specific Integrated Circuit (ASIC) configured to receive the OS image from the at least one data storage device and write the received OS image to the at least one non-volatile memory.

10. The semiconductor device of claim 9, wherein the at least one ASIC comprises:
at least one DRAM interface configured to receive the OS image from the at least one data storage device according to the DRAM protocol; and
at least one debug port configured to receive a boot loader from the data writer,
wherein the DRAM interface is initialized in response to executing the received boot loader.

11. The semiconductor device of claim 10, wherein the at least one ASIC comprises:
a processor connected to the at least one DRAM interface and the at least one debug port and the processor executing the boot loader to initialize the at least one DRAM interface;
and
a non-volatile memory interface connected to the processor and configured to receive the OS image from the processor using a non-volatile memory protocol.

12. (canceled)

13. The semiconductor device of claim 1, wherein the at least one debug port is configured to receive a Flash Translation Layer (FTL) code from the data writer and the at least one ASIC stores the received FTL code in the at least one data storage device and writes the OS image stored in the at least one data storage device to the at least one non-volatile memory device.

14. The semiconductor device of claim 10, wherein the at least one data storage device comprises:
a first port connected to the at least one DRAM interface of the at least one ASIC according to the DRAM protocol;
a second port connected to the data writer according to the DRAM protocol; and
a shared memory bank configured to be selectively accessed by the at least one ASIC through the first port and by the data writer through the second port based on an access authority,
wherein the OS image received from the data writer is transferred to the at least one ASIC through the second port, the shared memory bank and the first port in that order.

15. The semiconductor device of claim 14, wherein the at least one data storage device further comprises:
a first memory bank dedicated to the first port and accessed by the at least one ASIC; and
a second memory bank dedicated to the second port and accessed by the at least one data writer.

16. The semiconductor device of claim 15, wherein the OS image is stored in the shared memory bank through the second port.

17. The semiconductor device of claim 15, wherein a Flash Translation Layer (FTL) code received from at least one debug port is stored in the first memory bank through the first port.

18. The semiconductor device of claim 9, wherein the at least one data storage device comprises:
a first port connected to the at least one ASIC using a DRAM protocol;
a second port connected to at least one Field Programmable Gate Array (FPGA) according to the DRAM protocol, and configured to receive the OS image input from the data writer;
a memory area including a plurality of memory cells, the plurality of memory cells configured to store data provided by the first and second ports; and
an access controller configured to control access of the memory area by the at least one FPGA and the at least one ASIC.

19. The semiconductor device of claim 9, wherein the at least one data storage device comprises:
a first port connected to the at least one ASIC using a DRAM protocol;
a second port connected to at least one Field Programmable Gate Array (FPGA) according to the DRAM protocol, and configured to receive the OS image input from the data writer;
a plurality of memory banks including:
at least one first memory bank dedicated to the first port and accessed by the at least one ASIC,
at least one second memory bank dedicated to the second port and accessed by the at least one FPGA, and
at least one shared memory bank accessed by the at least one ASIC and the at least one FPGA using the first and second ports, respectively; and
a plurality of internal registers including:
a semaphore register configured to indicate an access authority of the first and second ports over the at least one shared memory bank,
a plurality of mail box registers configured to transmit messages between the first and second ports,
a plurality of check registers configured to indicate whether a message transmitted to the first or second port is read by the corresponding first or second port, and
at least one reserved register.

20. (canceled)

21. The semiconductor device of claim 9, wherein the at least one ASIC comprises:
a plurality of controllers, a first controller of the plurality of controllers connected to the at least one data storage device using the DRAM protocol and configured to receive the OS image from the at least one data storage device, and a second controller of the plurality of controllers connected to the at least one non-volatile memory and configured to write the received OS image to the at least one non-volatile memory;
an internal non-volatile memory configured to store a first boot loader, the first boot loader configured to initialize the first controller, and a Flash Translation Layer (FTL) code, the FTL code configured to change a logical address to a physical address; and
a processor configured to execute the first boot loader stored in the internal non-volatile memory and initialize the first controller, and store the FTL code in the at least one data storage device using the first controller.

22. The semiconductor device of claim 9, wherein the at least one ASIC comprises:
a plurality of controllers, a first controller of the plurality of controllers connected to the at least one data storage device using the DRAM protocol and configured to receive the OS image from the at least one data storage device, a second controller of the plurality of controllers connected to the at least one non-volatile memory and configured to write the received OS image to the at least one non-volatile memory, and a third controller of the plurality of controllers connected to the data writer using a Joint Test Action Group (JTAG) protocol and configured to receive a first boot loader and a Flash Translation Layer (FTL) code from the data writer;
a processor configured to execute a second boot loader stored in an internal non-volatile memory of the at least one ASIC, and configured to store the first boot loader received from the third controller in an internal volatile memory of the at least one ASIC and configured to execute the stored first boot loader; and
a bridge configured to change a protocol of data transferred between a plurality of buses of the at least one ASIC.

23. A data processing system (DPS), comprising:
a data writer including a processor, at least one field programmable gate array (FPGA) and at least one memory connected to the at least one FPGA; and
at least one semiconductor device including at least one data storage device, at least one Application Specific Integrated Circuit (ASIC) and at least one non-volatile memory, wherein the data writer is connected to the at least one semiconductor device using a DRAM protocol, and the data writer is configured to transfer an Operation System (OS) image to the at least one semiconductor device using the DRAM protocol.

24. The DPS of claim 23, wherein the data writer is connected to the at least one semiconductor device using a Joint Test Action Group (JTAG) protocol, and the data writer is configured to transfer a first boot loader and Flash Translation Layer (FTL) code to the at least one semiconductor device using the JTAG protocol.

25. The DPS of claim 23, wherein the at least one data storage device comprises:
a first port connected to the at least one ASIC using the DRAM protocol;
a second port connected to the at least one FPGA using the DRAM protocol;
a memory area including a plurality of memory cells, the plurality of memory cells configured to store data provided by the first and second ports; and
an access controller configured to control access of the memory area by the at least one FPGA and the at least one ASIC.

26. The DPS of claim 23, wherein the at least one data storage device comprises:
a first port connected to the at least one ASIC using the DRAM protocol;
a second port connected to the at least one FPGA using the DRAM protocol;
a plurality of memory banks including:
at least one first memory bank dedicated to the first port and accessed by the at least one ASIC,
at least one second memory bank dedicated to the second port and accessed by the at least one FPGA, and
at least one shared memory bank accessed by the at least one ASIC and the at least one FPGA using the first and second ports, respectively; and
a plurality of internal registers including:
a semaphore register configured to indicate an access authority of the first and second ports over the at least one shared memory bank,
a plurality of mail box registers configured to transmit messages between the first and second ports,
a plurality of check registers configured to indicate whether a message transmitted to the first or second port is read by the corresponding first or second port, and
at least one reserved register.

27. (canceled)

28. The DPS of claim 23, wherein the at least one ASIC comprises:
a plurality of controllers, a first controller of the plurality of controllers connected to the at least one data storage device using the DRAM protocol and configured to receive the OS image from the at least one data storage device, and a second controller of the plurality of controllers connected to the at least one non-volatile memory and configured to write the received OS image to the at least one non-volatile memory;
an internal non-volatile memory storing a first boot loader, the first boot loader used to initialize the first controller, and a Flash Translation Layer (FTL) code, the FTL code configured to change a logical address to a physical address; and
a processor configured to execute the first boot loader stored in the internal non-volatile memory and initialize the first controller, and store the FTL code in the at least one data storage device using the first controller.

29. The DPS of claim 24, wherein the at least one data storage device comprises:
a first port connected to the at least one ASIC using the DRAM protocol;
a second port connected to the at least one FPGA using the DRAM protocol;
a memory area including a plurality of memory cells, the plurality of memory cells configured to store data provided by the first and second ports; and
an access controller configured to control access of the memory area by the at least one FPGA and the at least one ASIC.

30. The DPS of claim 24, wherein the at least one data storage device comprises:
a first port connected to the at least one ASIC using the DRAM protocol;
a second port connected to the at least one FPGA using the DRAM protocol;
a plurality of memory banks including:
at least one first memory bank dedicated to the first port and accessed by the at least one ASIC,
at least one second memory bank dedicated to the second port and accessed by the at least one FPGA, and
at least one shared memory bank accessed by the at least one ASIC and the at least one FPGA using the first and second ports, respectively; and
a plurality of internal registers including:
a semaphore register configured to indicate an access authority of the first and second ports over the at least one shared memory bank,
a plurality of mail box registers configured to transmit messages between the first and second ports,
a plurality of check registers configured to indicate whether a message transmitted to the first or second port is read by the corresponding first or second port, and
at least one reserved register.

31. (canceled)

32. The DPS of claim 24, wherein the at least one ASIC comprises:
a plurality of controllers, a first controller of the plurality of controllers connected to the at least one data storage device using the DRAM protocol and configured to receive the OS image from the at least one data storage device, a second controller of the plurality of controllers connected to the at least one non-volatile memory and configured to write the received OS image to the at least one non-volatile memory, and a third controller of the plurality of controllers connected to the data writer using a Joint Test Action Group (JTAG) interface and configured to receive a first boot loader and a Flash Translation Layer (FTL) code from the data writer;
a processor configured to execute a second boot loader stored in an internal non-volatile memory of the at least one ASIC, and configured to store the first boot loader received from the third controller in an internal volatile memory of the at least one ASIC and configured to execute the stored first boot loader; and
a bridge configured to change a protocol of data transferred between a plurality of buses of the at least one ASIC.

33.-37. (canceled)
